(19) United States
(12) Patent Application Publication
(10) Pub. No.: US 2024/0119529 A1
(43) Pub. Date: Apr. 11, 2024

(54) MACHINE LEARNING BASED PERSONALIZED ETHICAL INTEREST AND SENSITIVITY PROFILE GENERATION FOR INVESTMENT MANAGEMENT

(71) Applicant: Morgan Stanley Services Group Inc., New York, NY (US)

(72) Inventor: Eren Kurshan, New York, NY (US)

(21) Appl. No.: 17/960,481

(22) Filed: Oct. 5, 2022

(51) Int. Cl. G06Q 40/06; G06F 40/20; G06N 20/00

(52) U.S. Cl. CPC G06Q 40/06; G06F 40/20; G06N 20/00

(57) ABSTRACT

An automated method of using machine learning (ML) to generate a customized ethical interest and sensitivity profile for investment management of an investor is provided. The method includes: compiling, from data sources supplied by the investor, interactions of the investor exhibiting ties to ethical interests related to investment decisioning; converting the compiled interactions into corresponding forms of the interactions that can be input to an ML module; classifying, using the ML module, the converted interactions by their corresponding ethical interests to identify the ethical interests of the investor; extracting, using the ML module, corresponding sensitivities of the identified ethical interests from the classified interactions, each corresponding sensitivity being one of positive, negative, or neutral; and generating the customized ethical interest and sensitivity profile from the identified ethical interests and their extracted corresponding sensitivities.

### FIELD OF THE DISCLOSURE

The present disclosure relates in general to systems and methods based on ethics related investment criteria, more specifically to systems and methods for deep learning-based personalized ethical interest profile generation for investment management, and even more specifically to deep learning-based personalized ethical interest and sensitivity profile generation in order to extend and customize environmental, social, and corporate governance (ESG) scores for investment management.

### BACKGROUND OF THE DISCLOSURE

Ethical investments and portfolio management have been studied by numerous researchers in the past decades. Ethical investments broadly imply a strategy where an investor chooses investments based on an ethical code. Various codes and metrics have been proposed, such as environmental, social, and corporate governance (ESG) criteria, which focuses on environmental, social, and governance standards for a company's operations. It is used by socially conscious investors to screen their potential investments. The primary components of ESG criteria are: (i) environment criteria (such as resource use, emissions, and innovation) that focus on the company's performance in terms of environmental stewardship; (ii) social criteria (such as workforce, human rights, community, and product responsibility) that are targeted at employee, customer, and community relationships; and (iii) governance criteria (such as management, shareholders, and CSR (corporate social responsibility) strategy) that relate, for example, to the company leadership, executive pay, shareholder rights, and audits/controls, to name a few. In recent years, socially conscious investment has picked up pace again. Investments under sustainability investments reached $17 trillion.

However, serious concerns have been raised on ethical portfolio and investment management processes. As highlighted by recent studies and articles, there are fundamental problems: (1) lack of investor awareness of ethical interests and sensitivities, (2) subjectivity of the criteria in ESG (e.g., aiming for a universal metric instead of a personalized metric), (3) range and diversity of personalized preferences; (4) quality of ESG evaluations and abuse; (5) quality of data used in ESG calculations and evaluations (such as relying on self-reported data from companies); (6) rigid portfolio management strategies based purely on ESG and related criteria (instead of a balanced optimization approach); and (7) divergence in ESG ratings from different rating agencies, including a lack of consistency or standards. These and other problems pose serious challenges to the implementation of ethical investing strategies. While regulators are looking into the definition of ESG closely and trying to define it, there is a serious mismatch between the demand for ethical investment and the supply of viable pathways.

It is in regard to these and other problems in the art that the present disclosure is directed to provide a technical solution for effective systems and methods for using machine learning to generate a customized ethical interest and sensitivity profile for investment management of an investor.

### SUMMARY OF THE DISCLOSURE

According to a first aspect of the disclosure, an automated method of using machine learning (ML) to generate a customized ethical interest and sensitivity profile for investment management of an investor is provided. The method comprises: compiling, by a processing circuit from data sources supplied by the investor, interactions of the investor exhibiting ties to ethical interests related to investment decisioning; converting, by the processing circuit, the compiled interactions into corresponding forms of the interactions that can be input to an ML module, the ML module being trained to classify converted interactions by their corresponding ethical interests; classifying, using the ML module, the converted interactions by their corresponding ethical interests to identify the ethical interests of the investor; extracting, using the ML module, corresponding sensitivities of the identified ethical interests from the classified interactions, the ML module being further trained for each ethical interest to extract a corresponding sensitivity from the classified interactions of the ethical interest, the corresponding sensitivity being one of positive, negative, or neutral; and generating, by the processing circuit, the customized ethical interest and sensitivity profile from the identified ethical interests and their extracted corresponding sensitivities.

In an embodiment consistent with the above, the method further comprises guiding, by the processing circuit, ethical investment decisions and portfolio management using the generated customized ethical interest and sensitivity profile.

In an embodiment consistent with the above, the generated customized ethical interest and sensitivity profile comprises: a customized ethical interest profile of the identified ethical interests; and a customized ethical sensitivity profile of the extracted corresponding sensitivities of the identified ethical interests.

In an embodiment consistent with the above, converting the compiled interactions comprises one or more of: performing natural language processing (NLP) on the compiled interactions in order to do sentiment analysis or language analysis of text data of the investor; performing deep learning based analysis of interactive data of the investor; and performing ML based analysis of unstructured data of the investor.

In an embodiment consistent with the above, the identified ethical interests comprise environmental, social, and corporate governance (ESG) components.

In an embodiment consistent with the above: the identified ethical interests divide into the ESG components and non-ESG components; and the method further comprises guiding, by the processing circuit, ethical investment decisions and portfolio management using a weighted combination of the ESG and non-ESG components of the identified ethical interests.

In an embodiment consistent with the above, the non-ESG components comprise privacy, security, transparency, and ethical operations.

In an embodiment consistent with the above, the investor comprises a group of investors, the method further comprising: repeating the compiling, converting, classifying, extracting, and generating steps for each of the group of investors in order to generate corresponding customized ethical interest and sensitivity profiles; and combining, by the processing circuit, the generated corresponding customized ethical interest and sensitivity profiles in order to generate the customized ethical interest and sensitivity profile of the group of investors.

In an embodiment consistent with the above, the data sources comprise one or more of historical profiles, transaction histories, interaction histories, research reports, surveys, trading histories, external data and profiles, social media, and blogs.

In an embodiment consistent with the above, the ML module comprises one or more of deep learning networks, neural networks, decision trees, and ensemble techniques.

In an embodiment consistent with the above, the method further comprises: sending, by the processing circuit, the generated customized ethical interest and sensitivity profile to the investor; receiving, by the processing circuit, feedback from the investor in response to the sent customized ethical interest and sensitivity profile; and finalizing, by the processing circuit, the customized ethical interest and sensitivity profile based on the received investor feedback.

In an embodiment consistent with the above, the method further comprises further training, by the processing circuit, the ML module based on the received investor feedback.

In an embodiment consistent with the above, the ethical interests are part of a standard and scientific criteria and taxonomy of ethical interest subcategorization.

According to another aspect of the disclosure, an automated system of using machine learning (ML) to generate a customized ethical interest and sensitivity profile for investment management of an investor is provided. The system comprises: a processing circuit; an ML circuit; and a non-transitory storage device storing instructions thereon that, when executed by the processing circuit, cause the processing circuit and the ML circuit to: compile, from data sources supplied by the investor, interactions of the investor exhibiting ties to ethical interests related to investment decisioning; convert the compiled interactions into corresponding forms of the interactions that can be input to an ML module of the ML circuit, the ML module being trained to classify converted interactions by their corresponding ethical interests; classify, using the ML module, the converted interactions by their corresponding ethical interests to identify the ethical interests of the investor; extract, using the ML module, corresponding sensitivities of the identified ethical interests from the classified interactions, the ML module being further trained for each ethical interest to extract a corresponding sensitivity from the classified interactions of the ethical interest, the corresponding sensitivity being one of positive, negative, or neutral; and generate the customized ethical interest and sensitivity profile from the identified ethical interests and their extracted corresponding sensitivities.

In an embodiment consistent with the system described above, the instructions, when executed by the processing circuit, further cause the processing circuit to guide ethical investment decisions and portfolio management using the generated customized ethical interest and sensitivity profile.

In an embodiment consistent with the system described above, the ML circuit converts the compiled interactions using one or more of: a natural language processing (NLP) module configured to perform NLP on the compiled interactions in order to do sentiment analysis or language analysis of text data of the investor; a deep learning module configured to perform deep learning based analysis of interactive data of the investor; and another ML module configured by machine learning to perform machine learning based analysis of unstructured data of the investor.

In an embodiment consistent with the system described above, the ML circuit comprises the deep learning module, and the interactive data comprises clickstream or gamification data of the investor.

In an embodiment consistent with the system described above, the investor comprises a group of investors and the instructions, when executed by the processing circuit, further cause the processing circuit and the ML circuit to: repeat the compiling, converting, classifying, extracting, and generating steps for each of the group of investors in order to generate corresponding customized ethical interest and sensitivity profiles; and combine the generated corresponding customized ethical interest and sensitivity profiles in order to generate the customized ethical interest and sensitivity profile of the group of investors.

In an embodiment consistent with the system described above, the instructions, when executed by the processing circuit, further cause the processing circuit to: send the generated customized ethical interest and sensitivity profile to the investor; receive feedback from the investor in response to the sent customized ethical interest and sensitivity profile; and finalize the customized ethical interest and sensitivity profile based on the received investor feedback.

In an embodiment consistent with the system described above, the instructions, when executed by the processing circuit, further cause the processing circuit and the ML circuit to further train the ML module based on the received investor feedback.

Any combinations of the various embodiments and implementations disclosed herein can be used. These and other aspects and features can be appreciated from the following description of certain embodiments together with the accompanying drawings and claims.

### BRIEF DESCRIPTION OF THE DRAWINGS

FIG. 1 is a block diagram of an example automated system of using machine learning (ML) to generate customized ethical interest and sensitivity profiles for investment management, according to an embodiment.

FIG. 2 is a flow diagram of an example automated method of using ML to generate customized ethical interest and sensitivity profiles for investment management of a group of clients, according to an embodiment.

FIG. 3 is a block diagram of an example customized ethical interest and sensitivity profile for investment management of a client, according to an embodiment.

FIG. 4 is a block diagram of an example automated system of using ML to generate customized ethical interest and sensitivity profiles for investment management of a group of investors, according to an embodiment.

FIG. 5 is a flow diagram of an example automated method of using ML to generate a customized ethical interest and sensitivity profile for investment management of an investor, according to an embodiment.

It is noted that the drawings are illustrative and not necessarily to scale, and that the same or similar features have the same or similar reference numerals throughout.

### DETAILED DESCRIPTION OF CERTAIN EMBODIMENTS OF THE DISCLOSURE

Example embodiments of the present disclosure are directed to automated techniques for using machine learning to generate a customized ethical interest and sensitivity profile for investment management of an investor. In an example method embodiment, this includes compiling, from data sources supplied by the investor, interactions of the investor exhibiting ties to ethical interests relating to investment decisioning. The method further includes converting the compiled interactions into corresponding forms of the interactions that can be input to a machine learning (ML) module. The ML module is trained to classify converted interactions by their corresponding ethical interests. In addition, the method includes classifying, using the ML module, the converted interactions in order to identify the ethical interests of the investor. The method also includes extracting, using the ML module, corresponding sensitivities of the identified ethical interests from the classified interactions. The ML module is further trained for each ethical interest to extract a corresponding sensitivity from the classified interactions of the ethical interest. Here, the corresponding sensitivity is one of positive, negative, or neutral. Finally, the method includes generating the customized ethical interest and sensitivity profile from the identified ethical interests and their extracted corresponding sensitivities.

Environmental, social, and corporate governance (ESG) ratings first emerged in the 1980's for investors to screen companies for key topics of interest (from environmental, social, and governance perspectives). The definition of ESG remains unclear and different for each provider (unlike credit worthiness definitions that have similar ratings). According to recent estimates, about $30 trillion of assets worldwide rely on ESG information in some way. In addition, over 3000 investors representing over $100 trillion in combined assets have signed a commitment to integrate ESG information to their investment decisions. This estimate has grown by 34% since 2016 due to the increased interest in ethical criteria. There are numerous providers of ESG ratings. In current ESG ratings, different providers focus on different indicators to calculate their respective ESG values. At a high level over 700 indicators have been reported that fall into a common taxonomy of 60+ categories, which makes the ESG ratings a complex and uneven landscape.

Recent studies highlight a significant amount of divergence in ESG ratings. For example, in many cases, the correlation between major ESG ratings is about 0.3. The source of this divergence has been attributed to factors such as measurement divergence, scope divergence, and weight divergence. These divergences cause confusion among investors and make it hard to choose between investment alternatives. According to research studies, ESG rating challenges and divergence is causing systemic problems in the markets and affecting asset prices in unpredictable ways.

It is in regard to these and other problems and challenges that embodiments of the present disclosure are directed to effective automated techniques for deep learning-based personalized ethical interest and sensitivity profile generation to extend and customize ESG scores for investment management. In some such embodiments, the techniques include integration of a processing circuit (such as a microprocessor or other programmable logic circuit) and a neuromorphic architecture to support the underlying learning functionality (such as a custom logic circuit, or the same or different microprocessor as the processing circuit). The ML circuit or architecture includes ML models trained or otherwise configured to do the ML functions, such as natural language processing (NLP), deep learning, and other ML tasks. In some embodiments, there is a non-transitory storage device (such as a disk drive or solid-state drive) storing instructions thereon that, when executed by the processing circuit, cause the processing circuit and the ML circuit to carry out the example automated techniques.

One of the fundamental challenges in the field of ethics is the subjectivity of criteria and variations of ethical criteria across different segments of the population as well as at an individual level. As highlighted in recent studies, ethical criteria and moral decisioning show significant variations across the globe, in different geographies, population segments, and even at an individual level. This challenges ethical portfolio management as it is hard to define universal ethical criteria to sufficiently address the demands of ethical investment seekers. Furthermore, in many cases the customers are not aware of the ethical topics to which they are sensitive. In some cases, it is not possible to extract such information by directly asking the client (e.g., investor). Hence, learning from customers' interactions and other learned behavior is more effective in extracting insights on ethics topics of interest and their sensitivities. In recent years, ethical interest topics have changed rapidly (e.g., the strong rise of gender equality and harassment in 2015-2016 was replaced with racial justice trends in 2020). This results in changes in weights of factors individual investors may be interested in for their portfolios.

Example embodiments of this disclosure address these issues by building (e.g., training) ML models that extract the ethical preferences of the individual from his or her own data profile through neural network-based solutions. In some such embodiments, this extends and strengthens the current ESG ratings for investment decisions, and customizes the ESG components and other (non-ESG) components for the individual investor. In some such embodiments, a vector representation of the customer's (e.g., investor's or group of investors') ethical preferences are extracted from data sources provided by the customer. These data sources can contain a variety of information about the customer's historical data and interactions. For example, the data sources can include, but are not limited to, historical profiles, transaction histories, interaction histories, research reports, surveys, trading histories, external data and profiles, social media, blogs, gamification interactions, video/image interactions, clickstreams, virtual reality (VR) interactions, natural language based interactions (spoken language, texts, and the like), historical data sources, profiles, donations, gifts, charity involvement, monetary and non-monetary transactions, and interest and engagement in research reports, white papers, and the like.

In some such embodiments, these ethical preferences break into several components. One such component is an extracted ethical interest vector/matrix/tensor/profile (or just profile for short, whether it is a vector, matrix, tensor, or some other indexed structure). The profile is for each individual client (e.g., investor of a group of investors). Interests include those ethical considerations the investor would like used for investment or portfolio management. Another component is a corresponding extracted ethical sensitivity vector/matrix/tensor/profile for each individual client. Sensitivities describe the extent (e.g., passionate, weakly interested) and direction (e.g., positive or negative, or perhaps zero or neutral) of an investor's ethical interest. In addition, in some circumstances, a corresponding aggregated ethical interest and sensitivity profile is provided for a client base (e.g., group of clients or investors). In some embodiments, this aggregated profile is an aggregation of the individual ethical interest and sensitivity profiles of the group. In some other embodiments, this aggregated profile is built as an individual profile only using aggregated sources representing the different investors in the group or the group as a whole (such as a social media channel for the group).

In one example scenario, customer A may be interested in animal rights and strongly interested in protecting them. Customer B may be interested in anti-corruption standards of a company from a governance standpoint. Customer C may be interested in the number of discrimination related lawsuits and settlements for a given company. Customer D may be interested in the food waste associated with a grocery chain company. Customer E may be interested in the negative effects of a software platform on teenagers and their development. In other words, different customers can have different ethical interests and sensitivities, which does not lend itself well to a one number fits all metric (such as ESG score) for making investment decisions.

In some embodiments, a processing circuit is configured (e.g., by code) in conjunction with a neural network architecture (e.g., by machine learning) to build an ethical interest vector by extracting key components of a client's ethical interest beyond the existing ESG criteria (of environmental, social and governmental components). By way of example, key ethical criteria that is in not included in ESG may include parts like privacy (e.g., is the company treating client's privacy in a way that is ethical or is the company selling client data?), security (e.g., is the company protecting and securing customers' confidential and personally identifiable information (PII), or is the company frequently suffering from hacks of its customer databases?), and customer service (e.g., is the company treating customers with dignity?) In one example embodiment, the processing and ML circuits are configured to identify and extract these non-ESG interests and incorporate them in the extracted ethical interest profile for each individual client.

In some such embodiments, the processing circuit and ML circuit are further configured to build a corresponding ethical sensitivity vector by extracting key components of a client's ethical sensitivity beyond the existing ESG criteria. By way of example, customer A's sensitivity to climate change related activities may be positive, while Customer B's sensitivity may be negative. However, customer A and B may each have low sensitivity to corporate government practices. As such, each customer has a personal or custom set of sensitivities to the various ethical interests. The customer sensitivity profile reflects a full range of profiles from highly sensitive to the corresponding ethical topics, to neutral and even negative sentiment associated with the topic.

In some such embodiments, the processing circuit and a configurable hybrid neural network architecture (or ML circuit) are further configured to build an aggregated ethical interest and sensitivity profile for a client base (e.g., group of clients, investors, or customers). Such a profile can be used to manage a single investment pool for a group of clients while being sensitive to each of the client's ethical interests. This profile can be constructed, for instance, by doing a (possibly) weighted combination of the interest and sensitivity profiles of the individuals, where the weights represent factors such as individual client size, investment, and importance, to name a few. For example, company A's client base may be sensitive to elderly abuse cases, while company B's client base may be more sensitive towards environmental toxin releases. In a similar fashion, different segments may have different preferences.

While a standard ESG profile is well understood, at least in terms of its basic components but not necessarily their weighting or other implementation methodology, non-ESG components can be represented in a variety of ways. By way of nonlimiting examples, according to some embodiments, ESG and non-ESG components in ethical interest and sensitivity profiles can be organized as one or more of: a standard ESG component (e.g., includes standard rating/scoring components included in ESG ratings); a personalized ESG component (e.g., includes a personalized ESG component with customized weights and other personalization); a personalized ESG-like component (e.g., includes an ESG-like component with partially overlapping topics but not standard ESG topics, customized to the client's interests); a standard non-ESG component (e.g., includes non-ESG standard components such as agency and research determined environmental metrics); and a fully personalized ethical profile component (e.g., includes fully personalized topic list customized based on client's personal interests and sensitivities).

In some embodiments, the extracted components or the generated profile is reviewed, revised, and confirmed by the customer before any action is taken using such components. As much of the profile generation uses neural network based machine learning, and as many customers appreciate having some degree of control of their investments, and as every customer has a different degree of delegation with which they are comfortable leaving an automated process to control their investment decisioning, this feedback step provides an opportunity for the customer to have the final approval on (or provide feedback for incorporate in) the generated ethical interest profile and its contents.

In some embodiments, the customer supplies input data sources to the automated ethical interest and sensitivity profile generator. These data sources may include, for example, interactions with the company, trading history, investment history, financial transactions such as donations, involvement in activities, interest and responsiveness to research reports/articles, and any other data sources the customer may provide that provide insight to the customer's ethical interests and sensitivities. In addition, in some embodiments, further profile information may be supplied by the customer and incorporated if available such as social media profiles, blogs, and other personal data sources into the body of material analyzed by the automated ethical interest and sensitivity extraction techniques. Such further information can include, for example, behavioral profile, risk appetite, and existing investment portfolio, to name a few.

In some embodiments, the generated profiles can be evaluated by the clients so that necessary revisions can be made before the profiles are used to make investment decisions or portfolio management. To this end, in some such embodiments, provisions are made to periodically let the client review and revise the evolving profile over time (such as yearly evaluation and refinements, or refinements are made each time the customer engages with the firm such as participating in programs, volunteering, donating, engaging gamified system for profiling, and the like). In some embodiments, a client's network of connections and their overall group and community characteristics may be incorporated into the profile in addition to individual characteristics of the client. By analyzing and extracting customer behavior and interaction profiles, the deep learning solution extracts a detailed customer profile. For example, in some such embodiments, social consciousness may be evaluated in a multi-dimensional way, beyond the restricted definitions of ESG.

In some embodiments, personalization of the ethical interest and sensitivity profile is achieved by training the ML tools (such as models, including deep learning models) to recognize ethical interests and sensitivities from alternative data sources based on the client's interest and sensitivity profiles. For instance, is the investor concerned about the treatment of elderly or disabled employees, or the number of lawsuits against the company related to social or discrimination matters, or negative news reports on environmental impact, to name a few. In some embodiments, the client may voluntarily participate in volunteer games to extract an ethical profile. While these can be as simple as surveys, in order to get deeper insight to a client's convictions, in some embodiments, gamification-based extraction is used, such as virtual reality (VR) games and interactive desktop or mobile applications in order to generate a range of ethical experiments and tests.

In some embodiments, normalization is used to refine the extracted profile of a client with respect to the rest of the clientele. This normalizes the profile within the broader client base in terms of ethics related interests and sensitivities. In some embodiments, the ethical profile generation techniques include aggregation of a group of individual ethical interest and sensitivity profiles (one profile for each client in a client base), in order to generate an aggregate profile for the client base. Such an aggregated profile for the client base can help with a number of functions such as corporate guidelines and corporate process alignment to serve clients' needs.

In some embodiments, corporate entities (e.g., corporations, companies) are profiled like individual clients, treating each corporate entity as if it were an individual person. For instance, activity and interactions for the corporate entity (such as their corporate social media channels) can be input to the techniques, and a resulting corporate profile generated. In some such embodiments, corporate and institutional clients are treated with the same profiling optimization as with individual clients. In some other embodiments, the aggregated profiles are generated by generating the individual client profiles followed by aggregating the generated individual profiles into an aggregated client base profile. In some other embodiments, the aggregated profiles are generated by aggregating all the input interactions of all the clients in the client base, and generating a single profile as if it were an individual client experiencing and interacting all the interactions of each of its constituent clients. By performing the same analysis on their client bases, the institutional clients may provide aggregated profiles to the investment management company to optimize the portfolio management strategies. This capability is important to retirement funds, institutional clients, corporate clients, and the like.

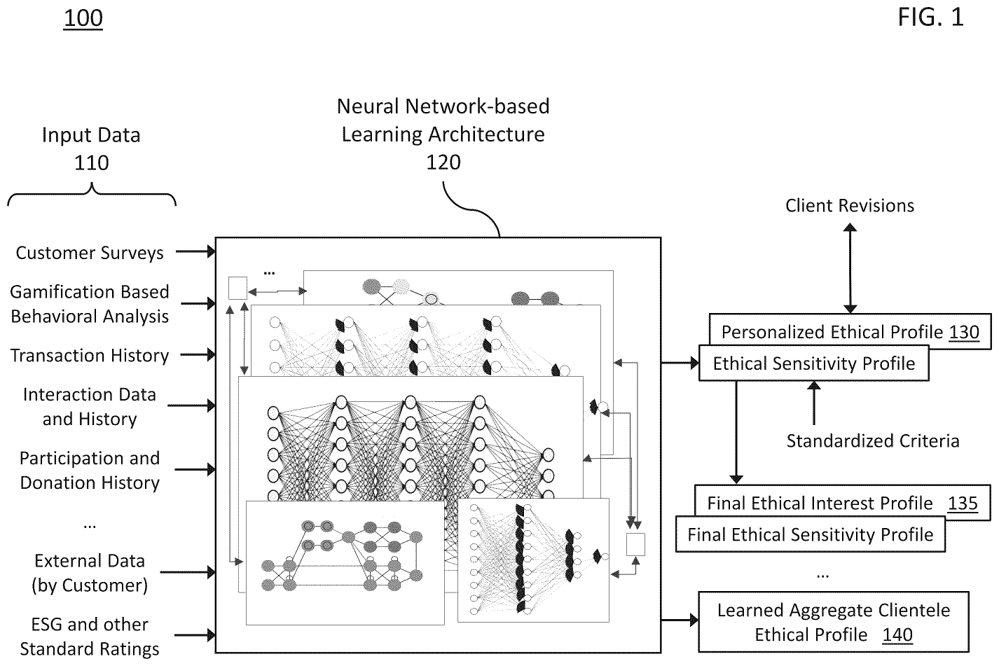

These and other embodiments will now be described with reference to FIGS. 1-5.

FIG. 1 is a block diagram of an example automated system 100 of using machine learning (ML) to generate customized ethical interest and sensitivity profiles for investment management, according to an embodiment. The system 100 includes a neural network-based learning architecture 120, such as numerous artificial neural networks and other ML tools trained or otherwise configured to extract ethical interests and corresponding sensitivities from different types of inputs 110 supplied by the investors being ethically profiled. The system 100 produces two types of profiles: (1) individual investor ethical interest and sensitivity profiles 130 (one per individual investor) and (2) an investor group ethical interest and sensitivity profile 140.

The neural network architecture used in the proposed approach is a hybrid neural network architecture with various configurable components that can be customized as needed. The connections and the boxes in FIG. 1 indicate this connectivity, where connector boxes include configurable connectors and multiplexors.

In further detail, the input data 110 can be any ethically relevant source (historical or current) of interactions about the investors or group of investors. This can include, but is not limited to, customer surveys, gamification-based behavioral analysis, transaction history, interaction data and history, donation and participation history, external data (provided by customer), and ESG and other standard ratings, to name a few. The learning architecture 120 includes different channels, cross-channels, and ensembles trained through machine learning to extract the ethical interests and corresponding sensitivities of the investors through their respective input sources 110. The learning architecture 120 learns from individual channels and cross channels the customer's personalized ethical vector and their custom sensitivity profile. For each client or investor, the learning architecture 120 generates a corresponding individual investor ethical interest and sensitivity profile 130 including a client personalized ethical profile (for the ethical interests of the client) and a client ethical sensitivity profile (for the corresponding sensitivities).

In some embodiments, the individual client or investor becomes involved by reviewing and providing corrective feedback (client revisions) to the generated profile 130. The feedback is used in creating a revised or intermediate profile 130, with possible re-reviews and corrections by the client until approved in final form 135. In some embodiments, inputs from standard and scientific criteria and taxonomy (standardized criteria) for the corresponding ethical interest subcategorization are used at this stage to control the possible profiles (interests and sensitivities) that can be finalized. When finalized, the personalized ethical profile 135 represents a compilation of the ethical topics of interest and corresponding sensitivities for the customer.

In some embodiments, the learning architecture 120 further outputs a learned aggregate clientele ethical profile 140 representing an aggregated ethical profile of the group of clients. Here, the learning architecture 120 can be input an aggregated set of interactions from all of the clients, or can form the aggregated profile 140 concurrently as a separate ML model that receives each of the individual interactions as input. In addition, the learning architecture 120 can also (or in place of) receive input from group sources representative of the client group (such as company social media channels when the group is the individual employees of the company), and use these inputs to generate (or further generate) the group profile 140.

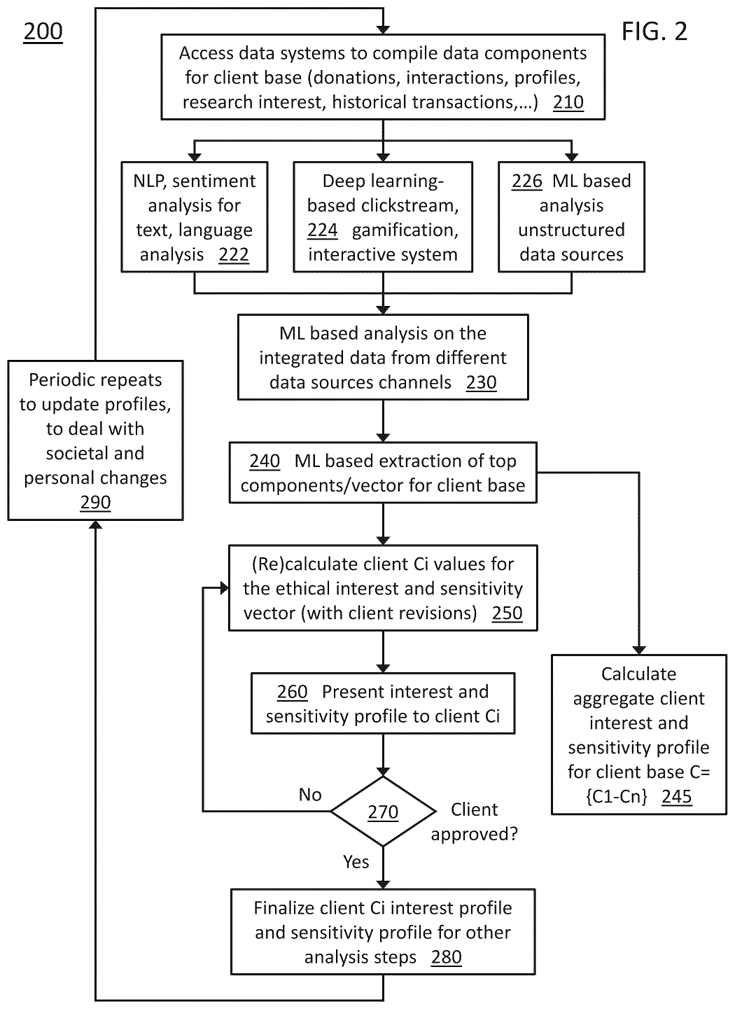

FIG. 2 is a flow diagram of an example automated method 200 of using ML to generate customized ethical interest and sensitivity profiles for investment management of a group of clients (or client base, such as a group of investors), according to an embodiment. For example, the steps of method 200 can be carried out by a combination of a processing circuit (e.g., computer, microprocessor, custom logic, or the like) and an ML circuit configured (such as programmed, trained through supervised learning, or the like) to perform the steps.

In the method 200, processing begins with the step of accessing 210 data systems or sources (such as supplied by the clients) to compile data components for the client base. These sources provide information used by the method 200 (such as through ML tools or models on the ML circuit) to form the ethical profiles. The source information can include, for example, donations, interactions, profiles, research interest, historical transactions, and the like. The next steps can be performed concurrently and involve using various ML tools to convert the various components into a format that can be input to the ML models (that perform the ML-based interest identification and corresponding sensitivity extraction. The conversion includes, for example, the steps of natural language processing (NLP) 222 for sentiment and language analysis of text data (text interactions), deep learning 224 based analysis of clickstream, gamification, and other interactive system activity (behavioral interactions), and machine learning 226 (ML) based analysis of unstructured data sources (other interactions). The conversion readies the input source data for processing by an ML module responsible for identifying or classifying ethical interests from the interactions.

The method 200 further includes the step of machine learning 230 based analysis on the integrated data from different data source channels, such as by the ML module. The ML module is trained on identifying or classifying integrated data (or interactions) by the particular ethical interest the data represents. Next, the method 200 includes the step of machine learning 240 based extraction of top components (or vectors) of sensitivities for the client and the client base. This can be done by the ML module (or family of modules, such as by ethical interest), which is further trained to estimate or evaluate sensitivities for ethical interests from the classified interactions identified with those corresponding ethical interests. These sensitivities are then incorporated into corresponding ethical profiles built for the individual clients as well as for the group of clients (client base).

For instance, if the identified ethical interest and corresponding sensitivity was from a particular client Ci, then the method 200 proceeds with the steps of calculating 250 (or adjusting) client Ci's values for its ethical interest and sensitivity vector to reflect the newly determined ethical interest and corresponding sensitivity, as well as calculating 245 (or adjusting) the aggregate client (client base, such as clients Cl through Cn) interest and sensitivity profile to reflect the same interest and sensitivity. On the other hand, if the identified interest and extracted sensitivity is only associated with the client base as a whole (and not an individual client, then only step 245 (aggregate client update) is performed.

After the input sources have been exhausted (or some other input termination event has taken place, such as time or data based), processing continues with the step of, for each client Ci, presenting 260 the initial (or current) interest and sensitivity profile to client Ci for approval or feedback. While the automated ML approach to determining a client's interests and corresponding sensitivities might be an entirely accurate depiction, the client may not be comfortable with such a depiction being used for investment management. For the step of approving 270 the current interest and sensitivity profile, the client Ci may disapprove (No) by supplying revisions to the generated profile and having the processing return to the step of recalculating 250 client Ci's profile values in view of the revisions. At this stage explicit inputs, weight factors, and other customizations may be performed by the client. In some embodiments, the method 200 may further train the ML module based on this feedback, in order to better classify and extract the client Ci's (and possibly other clients) interests and sensitivities on future profile generation.

On the other hand, if at the step of approving 270 the current interest and sensitivity profile, the client Ci approves (Yes) the profile, processing proceeds to the step of finalizing 280 the client Ci's interest profile and sensitivity profile for other analysis and other use steps, such as for guiding investment decisions and portfolio management for the client Ci. Lastly, the process 200 includes the step of periodically (e.g., every year) repeating 290 the process 200 to update profiles, such as to deal with societal and personal changes that would cause one's ethical interests or sensitivities to change.

It is important to note that due to the nature of extraction the proposed ethical interest and sensitivity profiles are significantly more complex than surveys. A multitude of sub-profile components, complex tensor weight functions, context-specific aspects as well as actionability and other behavioral characteristics are incorporated in the profile. These components make the resulting ethical interest and sensitivity profile more functionable in the later stages such as investment decisions. As an example, through the gamification system the profiling determines how actionable the clients interest in a specific topic is, which is then used for later investment decisioning at run-time (without customer input in an automated fashion).

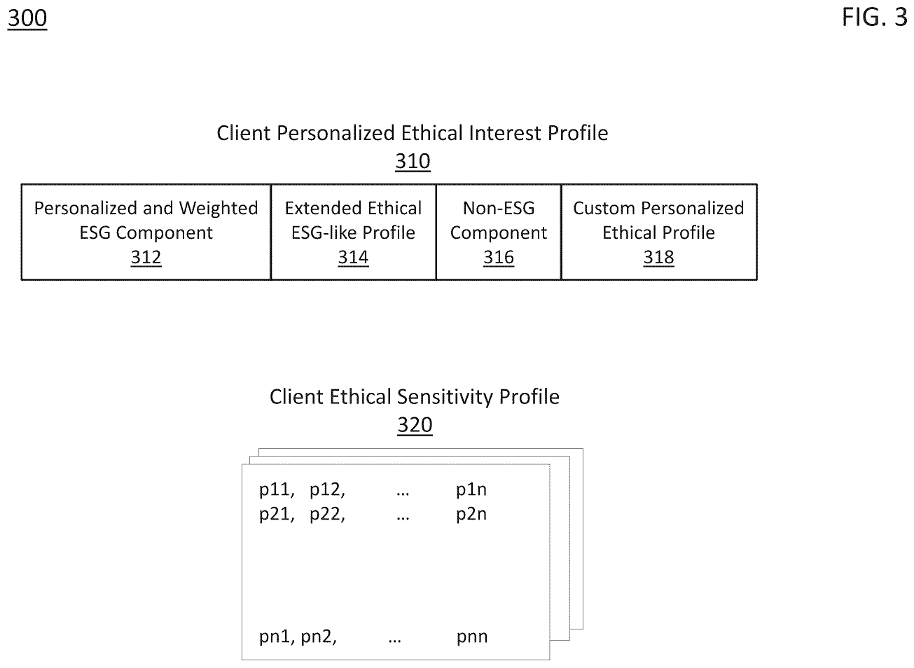

FIG. 3 is a block diagram of an example customized ethical interest and sensitivity profile 300 for investment management of a client, according to an embodiment. The profile 300 is depicted in two parts: a client personalized ethical interest profile 310 (for ethical interests of the client, such as a vector of interests) and a client ethical sensitivity profile 320 (for the client's corresponding sensitivities, such as a corresponding vector of sensitivities). In some embodiments, the interest profile 310 is broken up into two or more interest profile components (groups of ethical interests falling into specific categories). In FIG. 3, the interest profile 310 is broken up into four interest profile components: a personalized and weighted ESG component 312, an extended ethical ESG-like profile 314, a non-ESG component 316, and a custom personalized ethical profile 318. In addition, sensitivity is a broad term referring generally to a (signed) numeric quantity useful in distinguishing the importance/relevance/weight of one ethical interest to another. Sensitivity profile components (e.g., sensitivities, weights) are identified as pij (e.g., p11, p12, p21, . . . ) in the sensitivity profile 320.

While the interest profile 310 and sensitivity profile 320 are depicted as two entities in FIG. 3, in practice they may be implemented with a single structure. In addition, in some embodiments, the sensitivity profile 320 (or even the interest profile 310) may be multi-dimensional. For instance, in FIG. 3, the sensitivity profile 320 is depicted as a tensor of profile components pij (such as sensitivities), but in other embodiments, the sensitivity profile 320 may instead be a matrix (e.g., one vector of sensitivities per ethical interest) or a vector (e.g., one sensitivity per ethical interest) of sensitivity profile components.

Some aspects of the interest profile 310 are directed to environmental, social, and governance (ESG) interests, such as personalized and weighted ESG component 312. Other aspects are directed to non-ESG ethical interests, such as non-ESG component 316. While some embodiments may include an ESG component that is faithful to a standard ESG rating or score, interest profile 310 includes a personalized and weighted ESG component 312. This ESG component 312 is selective in which ESG interests are included (i.e., personalized). In some embodiments, the personalization is based on classifying such interests from ML techniques applied to supplied interactions by the client (e.g., as described above with reference to FIG. 2). The interests in this personalized ESG component 312 are also weighted based on preferences ascertained from the client and not necessarily the weights used in any standard ESG weighting of the different ESG interests used to produce a standardized ESG score.

There are many ways to organize the ethical interests and corresponding sensitivities of a customized ethical interest and sensitivity profile 300 for investment management of a client that are consistent with embodiments of the present disclosure. FIG. 3 is but one example. The non-ESG component 316 is an extended ethical profile that includes ethical interests beyond the standard ESG interests (in the ESG component 312). The non-ESG component 316 includes non-ESG interests such as privacy, security, human rights, and transparency, to name a few.

The extended ethical ESG-like profile 314 includes ethical interests related to environmental, social, and corporate governance, but strictly speaking are not part of any standard ESG interest set. Accordingly, such interests do not properly belong in the ESG component 312 or the non-ESG component 316. The ESG-like profile 314 can thus include broadened non-standard interpretations of ethical interests related to ESG focus areas.

The custom personalized ethical profile 318 can be a catchall for any ethical interest or customization that does not lend itself well to one of the other three interest profile components 312, 314, and 316. It can be fully customized and personalized based on the client's ethical interests with no forced intersection with ESG, non-ESG, or ESG-like interests. The custom personalize ethical profile 318 can also be multi-dimensional (e.g., a matrix or tensor of interests) to represent variable interest vectors (such as those that change with time or other circumstances).

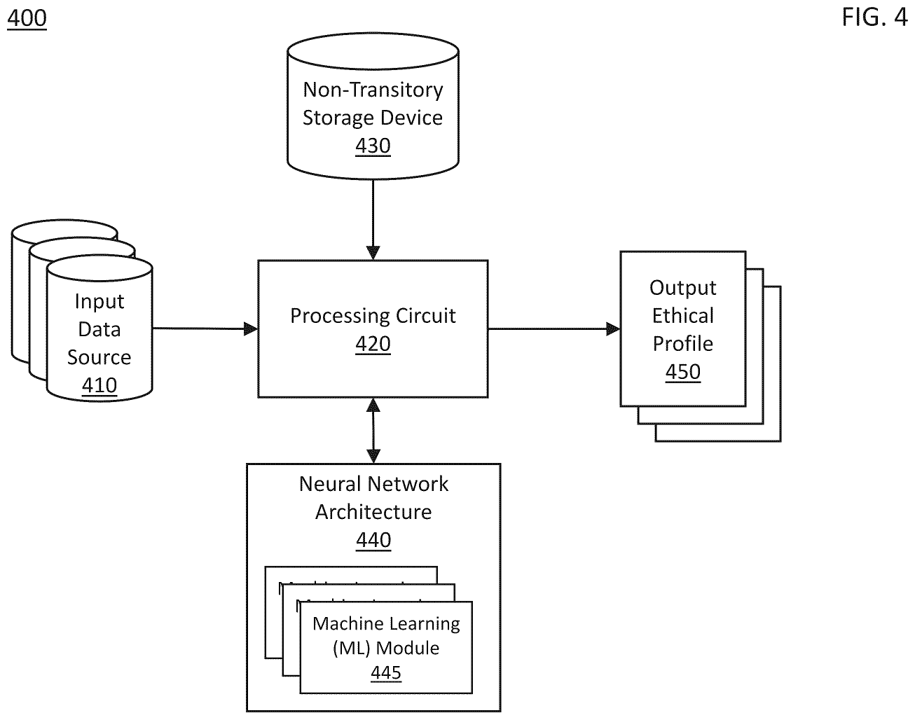

FIG. 4 is a block diagram of an example automated system 400 of using ML to generate customized ethical interest and sensitivity profiles for investment management of a group of investors, according to an embodiment. The system 400 includes a set of input data sources 410 (e.g., as supplied by the investors) for providing input data (e.g., interactions of the investors that reflect ethical interests and sensitivities). The system 400 also includes a processing circuit 420 (such as a microprocessor, computer, or custom logic circuit) configured (e.g., by code or custom logic) to carry out the tasks of the system 400. In addition, the system 400 includes a non-transitory storage device 430 (such as a disk drive or solid state drive) for storing instructions that, when executed by the processing circuit 420, cause the processing circuit 420 to carry out its assigned tasks.

Further, the system 400 includes a neural network architecture 440 (or neuromorphic architecture), such as another microprocessor or dedicated custom logic circuit, or possibly different physical or logical components of the processing circuit 420. The neural network architecture 440 is for carrying out the ML (machine learning) tasks, and is sometimes referred to as a neural network based learning architecture or a machine learning (ML) circuit. The neural network architecture sometimes does (or is configured to do) ML tasks that are not neural network tasks. The neural network based learning architecture 440, which may be implemented over neuromorphic hardware in some embodiments, includes multiple ML modules 445 (e.g., physical or logical computation, neural network, or other processing components of the ML circuit 440 dedicated to specific ML tasks, such as classifying and extracting). In addition, the processing circuit 420, with the help of the neural network architecture 440, converts the input data sources 410 into output ethical profiles 450 for their respective investors.

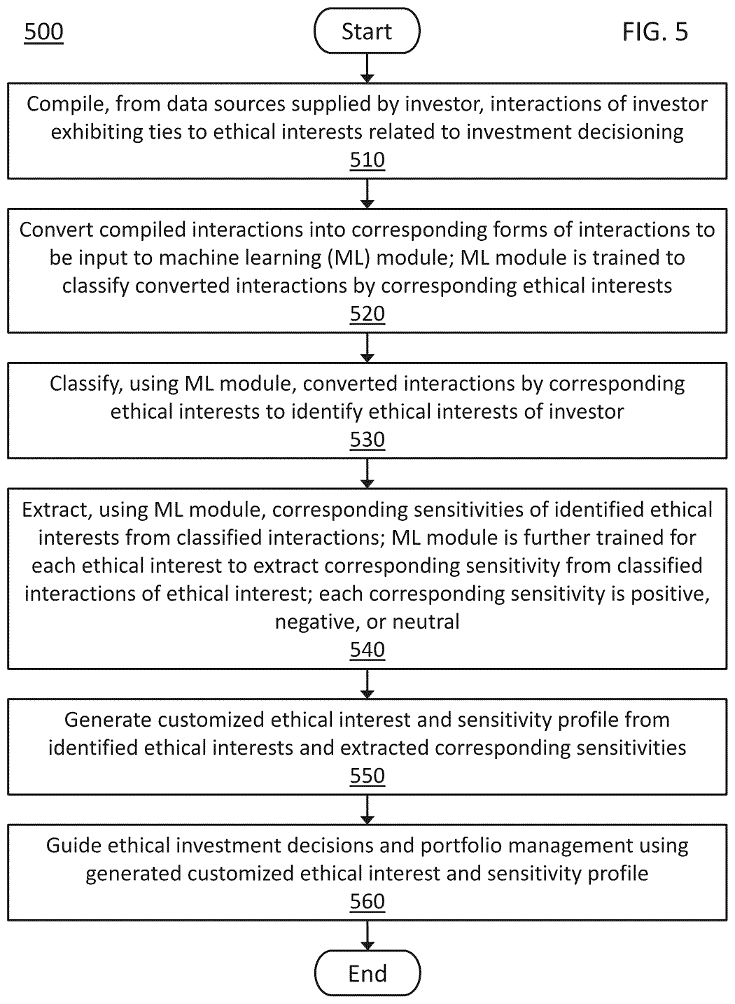

FIG. 5 is a flow diagram of an example automated method 500 of using ML (such as with neural network architecture 440) to generate a customized ethical interest and sensitivity profile (such as ethical interest and sensitivity profile 300) for investment management of an investor (or client), according to an embodiment. The method 500 of FIG. 5 is intended to be performed on a computing or processing circuit (such as processing circuit 420) that is configured (e.g., by code) to carry out the steps of the method 500 using information supplied by the investor. It should be noted that while the method 500 of FIG. 5 is depicted in a way that could be interpreted as a sequential process, this is for ease of illustration, and the method 500 does not have to be sequential. In general, the steps in method 500 can be run in parallel or simultaneously (or concurrently) through the same or different neural network architectures or components. Neural networks have high levels of parallelism in their processing, and can extract a multitude of different profile characteristics from the same run, as opposed to the sequential steps used in traditional profiling schemes.

Processing begins with the step of compiling 510, by the processing circuit from data sources (such as input data sources 410) supplied by the investor, interactions (e.g., survey data, text data, interactive data) of the investor exhibiting ties to ethical interests related to investment decisioning. The method 500 further includes the step of converting 520, by the processing circuit, the compiled interactions into corresponding forms of the interactions that can be input to an ML module (such as ML module 445). The ML module is trained to classify converted interactions by their corresponding ethical interests. In addition, the method 500 includes the step of classifying 530, using the ML module, the converted interactions by their corresponding ethical interests to identify the ethical interests of the investor.

The method 500 also includes the step of extracting 540, using the ML module (such as ML module 445), corresponding sensitivities of the identified ethical interests from the classified interactions. The ML module is further trained for each ethical interest to extract a corresponding sensitivity from the classified interactions of the ethical interest. The corresponding sensitivity is one of positive, negative, or neutral, possibly with an associated magnitude (such as a signed number). Further, the method 500 includes the step of generating 550, by the processing circuit, the customized ethical interest and sensitivity profile from the identified ethical interests and their extracted corresponding sensitivities. In addition, the method 500 includes the step of guiding, by the processing circuit, ethical investment decisions and portfolio management using the generated customized ethical interest and sensitivity profile.

In an embodiment, the generated customized ethical interest and sensitivity profile includes a customized ethical interest profile (such as interest profile 310) of the identified ethical interests and a customized ethical sensitivity profile (such as sensitivity profile 320) of the extracted corresponding sensitivities of the identified ethical interests. In an embodiment, the step of converting 520 the compiled interactions includes one or more of the steps of: performing natural language processing (NLP) on the compiled interactions in order to do sentiment analysis or language analysis of text data of the investor; performing deep learning based analysis of interactive data of the investor; and performing ML based analysis of unstructured data of the investor. In an embodiment, the step of converting 520 the compiled interactions includes the step of performing the deep learning based analysis, and the interactive data includes clickstream or gamification data of the investor. In an embodiment, the method 500 further includes the step of guiding, by the processing circuit, corporate governance guidelines and processes using the generated customized ethical interest and sensitivity profile.

In an embodiment, the identified ethical interests include environmental, social, and corporate governance (ESG) components. In an embodiment, the ESG components include standard ESG ratings and scores. In an embodiment, the standard ESG ratings and scores include environmental ratings and breakdowns. In an embodiment, the identified ethical interests divide into the ESG components (such as ESG components 312) and non-ESG components (such as non-ESG components 314), and the step of guiding 560 the ethical investment decisions and portfolio management includes using a weighted combination of the ESG and non-ESG components of the identified ethical interests. In an embodiment, the non-ESG components include privacy, security, transparency, and ethical operations.

In an embodiment, the investor includes a group of investors (such as a client base), and the method 500 further includes the steps of: repeating the compiling, converting, classifying, extracting, and generating steps for each of the group of investors in order to generate corresponding customized ethical interest and sensitivity profiles; and combining, by the processing circuit, the generated corresponding customized ethical interest and sensitivity profiles in order to generate the customized ethical interest and sensitivity profile of the group of investors. In an embodiment, the data sources include one or more of historical profiles, transaction histories, interaction histories, research reports, gamification-based interest profiles, surveys, trading histories, external data and profiles, social media, and blogs. In an embodiment, the ML module includes one or more of deep learning networks, neural networks, decision trees, and ensemble techniques.

In an embodiment, the method 500 further includes the steps of: sending, by the processing circuit, the generated customized ethical interest and sensitivity profile to the investor; receiving, by the processing circuit, feedback from the investor in response to the sent customized ethical interest and sensitivity profile; and finalizing, by the processing circuit, the customized ethical interest and sensitivity profile based on the received investor feedback. In an embodiment, the method 500 further includes the step of further training, by the processing circuit, the ML module based on the received investor feedback. In an embodiment, the ethical interests are part of a standard and scientific criteria and taxonomy of ethical interest subcategorization.

The different logic components (e.g., processing circuit, neural network architecture, neuromorphic circuitry) described throughout can be implemented in a variety of ways, including hardware (e.g., custom logic circuits), firmware (such as with customizable logic circuits), or software (e.g., computer instructions executable on a processing circuit such as an electronic processor or microprocessor). These components can include computing, control, or other logic circuits configured (e.g., programmed) to carry out their assigned tasks. In some example embodiments, their logic is implemented as computer code configured to be executed on a computing circuit (such as a microprocessor) to perform the steps that are part of the technique.

The automated methods described herein can be implemented by an electronic circuit configured (e.g., by code, such as programmed, by custom logic, as in configurable logic gates, or the like) to carry out the steps of the method. Some or all of the methods described herein can be performed using the components and techniques illustrated in FIGS. 1-4. In addition, these methods disclosed herein can be performed on or using programmed logic, such as custom or preprogrammed control logic devices, circuits, or processors. Examples include a programmable logic circuit (PLC), computer, software, or other circuit (e.g., ASIC, FPGA) configured by code or logic to carry out their assigned task. The devices, circuits, or processors can also be, for example, dedicated or shared hardware devices (such as laptops, single board computers (SBCs), workstations, tablets, smartphones, part of a server, or dedicated hardware circuits, as in FPGAs or ASICs, or the like), or computer servers, or a portion of a server or computer system. The devices, circuits, or processors can include a non-transitory computer readable medium (CRM, such as read-only memory (ROM), flash drive, or disk drive) storing instructions that, when executed on one or more processors, cause these methods to be carried out.

Any of the methods described herein may, in corresponding embodiments, be reduced to a non-transitory computer readable medium (CRM, such as a disk drive or flash drive) having computer instructions stored therein that, when executed by a processing circuit, cause the processing circuit to carry out an automated process for performing the respective methods.

The methods described herein may be performed in whole or in part by software or firmware in machine readable form on a tangible (e.g., non-transitory) storage medium. For example, the software or firmware may be in the form of a computer program including computer program code adapted to perform some of the steps of any of the methods described herein when the program is run on a computer or suitable hardware device (e.g., FPGA), and where the computer program may be embodied on a computer readable medium. Examples of tangible storage media include computer storage devices having computer-readable media such as disks, thumb drives, flash memory, and the like, and do not include propagated signals. Propagated signals may be present in a tangible storage media, but propagated signals by themselves are not examples of tangible storage media. The software can be suitable for execution on a parallel processor or a serial processor such that the method steps may be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It is further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. An automated and computer-based method of using machine learning (ML) to generate a customized ethical interest and sensitivity profile for investment management of an investor, the method comprising:
providing a hardware-based processing circuit, a non-transitory storage device storing instructions thereon, and an artificial neural network including a plurality of nodes in a plurality of layers and configured to perform the machine learning;
training the artificial neural network to classify input interactions of the investor by ethical interests corresponding to the input interactions;
receiving individual interactions of the investor;
compiling, by the processing circuit from data sources supplied by the investor, the individual interactions of the investor exhibiting ties to ethical interests related to investment decisioning;
converting, by the processing circuit, the compiled interactions into corresponding forms of the interactions that can be input to the trained artificial neural network, the artificial neural network being trained to classify converted interactions by their corresponding ethical interests;
classifying, using the trained artificial neural network, the converted interactions by their corresponding ethical interests to identify the ethical interests of the investor;
extracting, using the trained artificial neural network, corresponding sensitivities of the identified ethical interests from the classified interactions, the trained artificial neural network being further trained for each ethical interest to extract a corresponding sensitivity from the classified interactions of the ethical interest, the corresponding sensitivity being one of positive, negative, or neutral; and
generating, by the processing circuit, the customized ethical interest and sensitivity profile of the investor and personalized to the investor from the identified ethical interests and their extracted corresponding sensitivities.

2. The computer-based method of claim 1, further comprising guiding, by the processing circuit, ethical investment decisions and portfolio management using the generated customized ethical interest and sensitivity profile.

3. The computer-based method of claim 1, wherein the generated customized ethical interest and sensitivity profile comprises:
a customized ethical interest profile of the identified ethical interests; and
a customized ethical sensitivity profile of the extracted corresponding sensitivities of the identified ethical interests.

4. The computer-based method of claim 1, wherein converting the compiled interactions comprises one or more of:
performing natural language processing (NLP) on the compiled interactions in order to do sentiment analysis or language analysis of text data of the investor;
performing deep learning based analysis of interactive data of the investor; and
performing ML based analysis of unstructured data of the investor.

5. The computer-based method of claim 1, wherein the identified ethical interests comprise environmental, social, and corporate governance (ESG) components.

6. The computer-based method of claim 5, wherein:
the identified ethical interests divide into the ESG components and non-ESG components; and
the method further comprises guiding, by the processing circuit, ethical investment decisions and portfolio management using a weighted combination of the ESG and non-ESG components of the identified ethical interests.

7. The computer-based method of claim 6, wherein the non-ESG components comprise privacy, security, transparency, and ethical operations.

8. The computer-based method of claim 1, wherein the investor comprises a group of investors, the method further comprising:
repeating the compiling, converting, classifying, extracting, and generating steps for each of the group of investors in order to generate corresponding customized ethical interest and sensitivity profiles; and
combining, by the processing circuit, the generated corresponding customized ethical interest and sensitivity profiles in order to generate the customized ethical interest and sensitivity profile of the group of investors.

9. The computer-based method of claim 1, wherein the data sources comprise one or more of historical profiles, transaction histories, interaction histories, research reports, surveys, trading histories, external data and profiles, social media, and blogs.

10. The computer-based method of claim 1, wherein the artificial neural network comprises one or more of deep learning networks, decision trees, and ensemble techniques.

11. The computer-based method of claim 1, further comprising:
sending, by the processing circuit, the generated customized ethical interest and sensitivity profile to the investor;
receiving, by the processing circuit, feedback from the investor in response to the sent customized ethical interest and sensitivity profile; and
finalizing, by the processing circuit, the customized ethical interest and sensitivity profile based on the received investor feedback.

12. The computer-based method of claim 11, further comprising further training, by the processing circuit, the artificial neural network based on the received investor feedback.

13. The computer-based method of claim 1, wherein the ethical interests are part of a standard and scientific criteria and taxonomy of ethical interest subcategorization.

14. An automated system of using machine learning (ML) to generate a customized ethical interest and sensitivity profile for investment management of an investor, the system comprising:
a hardware-based processing circuit;
an artificial neural network including a plurality of nodes configured in a plurality of layers configured to perform the machine learning; and
a non-transitory storage device storing instructions thereon that, when executed by the processing circuit, cause the processing circuit and the artificial neural network to:
train the artificial neural network to classify input interactions of the investor by ethical interests corresponding to the input interactions;
receive individual interactions of the investor;
compile, from data sources supplied by the investor, the individual interactions of the investor exhibiting ties to ethical interests related to investment decisioning;
convert the compiled interactions into corresponding forms of the interactions that can be input to the trained artificial neural network, the artificial neural network being trained to classify converted interactions by their corresponding ethical interests;
classify, using the trained artificial neural network, the converted interactions by their corresponding ethical interests to identify the ethical interests of the investor;
extract, using the trained artificial neural network, corresponding sensitivities of the identified ethical interests from the classified interactions, the trained artificial neural network being further trained for each ethical interest to extract a corresponding sensitivity from the classified interactions of the ethical interest, the corresponding sensitivity being one of positive, negative, or neutral; and
generate the customized ethical interest and sensitivity profile of the investor and personalized to the investor from the identified ethical interests and their extracted corresponding sensitivities.

15. The system of claim 14, wherein the instructions, when executed by the processing circuit, further cause the processing circuit to guide ethical investment decisions and portfolio management using the generated customized ethical interest and sensitivity profile.

16. The system of claim 14, wherein the artificial neural network converts the compiled interactions using one or more of:
a natural language processing (NLP) module configured to perform NLP on the compiled interactions in order to do sentiment analysis or language analysis of text data of the investor;
a deep learning module configured to perform deep learning based analysis of interactive data of the investor; and
another artificial neural network configured by machine learning to perform machine learning based analysis of unstructured data of the investor.

17. The system of claim 16, wherein the artificial neural network comprises the deep learning module, and the interactive data comprises clickstream or gamification data of the investor.

18. The system of claim 14, wherein the investor comprises a group of investors and wherein the instructions, when executed by the processing circuit, further cause the processing circuit and the artificial neural network to:
repeat the compiling, converting, classifying, extracting, and generating steps for each of the group of investors in order to generate corresponding customized ethical interest and sensitivity profiles; and
combine the generated corresponding customized ethical interest and sensitivity profiles in order to generate the customized ethical interest and sensitivity profile of the group of investors.

19. The system of claim 14, wherein the instructions, when executed by the processing circuit, further cause the processing circuit to:
send the generated customized ethical interest and sensitivity profile to the investor;
receive feedback from the investor in response to the sent customized ethical interest and sensitivity profile; and
finalize the customized ethical interest and sensitivity profile based on the received investor feedback.

20. The system of claim 19, wherein the instructions, when executed by the processing circuit, further cause the processing circuit and the artificial neural network to further train the artificial neural network based on the received investor feedback.
